(19) United States
(12) Patent Application Publication
(10) Pub. No.: US 2025/0205714 A1
(43) Pub. Date: Jun. 26, 2025

(54) SEPARATOR

(71) Applicant: GEA WESTFALIA SEPARATOR GROUP GMBH, Oelde (DE)

(72) Inventors: Andreas SCHULZ, Beckum (DE); Kai HELMRICH, Drensteinfurt (DE); Kathrin QUITER, Drensteinfurt (DE); Steffen LAACKMANN, Wadersloh (DE)

(21) Appl. No.: 18/852,023

(22) PCT Filed: Feb. 2, 2023
(86) PCT No.: PCT/EP2023/052598

§ 371 Date: Sep. 27, 2024

(30) Foreign Application Priority Data
Mar. 29, 2022 (DE) 20 2022 101 640.2

(51) Int. Cl. B04B 1/08; B04B 9/02

(52) U.S. Cl. CPC B04B 1/08; B04B 9/02

(57) ABSTRACT

A separator has a frame with receiving areas for rotatably supporting the separator insert. Each receiving area having a stator device as a sub-element of a magnet bearing device, and a separator insert as a pre-assembled replaceable unit for inserting into stator units on a frame or in a housing of the separator. The separator insert has: i) a rotor rotatable about a rotational axis and which having a drum and a drum wall, and ii) at least two rotor units as sub-elements of the magnet bearing devices at two axially spaced positions of the rotor with the drum. The rotor units hold, rotatably support, and rotate the rotor together with the drum in a suspended manner within the housing during a separation mode. The separator has at least one linear drive for linearly moving at least one of the two receiving areas relative to the separation insert.

### BACKGROUND AND SUMMARY OF THE INVENTION

Exemplary embodiments of the invention relate to a separator having a separator insert.

Separators as defined in this document are used to separate a free-flowing suspension as a starting product in a centrifugal field into phases of different densities. Steam sterilization of the used separators is required for a wide variety of applications. A relatively “small” steam-sterilizable separator with disk stack introduced to the market by the applicant is the separator “CSC 6” with 6000 m² equivalent clarifying surface. However, in some situations, such as in the laboratory, this machine is still relatively large. The known separators with disk stack available on the market are driven by a spindle, which in turn is driven by a motor either directly or via a gear. In addition, the known machines are made of stainless steel. For these reasons, filters are currently very often used in laboratories instead of centrifugal separators. Steam sterilization (SIP—Sterilization In Place) would not be necessary for a separator with a disk stack and disposable plastic components (single-use technology—single use of pre-qualified plastic parts). It could be particularly suitable for use in biotechnology.

A separator for separating a flowable product into different phases is known from WO 2014/000829 A1, which has a rotatable drum with a lower drum part and an upper drum part and a means arranged in the drum for processing a suspension in the centrifugal field of solids or for separating a heavy solid-like phase from a lighter phase in the centrifugal field, wherein one, several or all of the following elements are made of plastic or a plastic composite material: the lower drum part, the upper drum part, the means for clarifying. In this way, it is possible to design part of the drum or preferably even the entire drum—preferably together with the inlet and outlet systems or areas—for single use, which is of particular interest and advantage with regard to the processing of pharmaceutical products such as fermentation broths or the like, since after operation for processing a corresponding product batch in preferably continuous operation during the processing of the product batch, no cleaning of the parts of the drum in contact with the product has to be carried out, but the entire drum can be replaced. This separator is therefore very advantageous, particularly from a hygienic point of view. In order to achieve a physical separation between this disposable drum and the drive, a contact-free coupling between drive and drum is advantageous.

A further development is shown in DE 10 2017 128 027, where the bearing devices are designed as magnetic bearings and one of the magnetic bearing devices is preferably also used as a drive device for rotating the drum, which is held in suspension during operation. This eliminates the need for mechanical components for rotating and bearing the drum, which promotes the design as a separator with a separator insert for one-time use, since replacing this separator insert is very easy to handle. The present invention also makes use of these advantages.

Against this background, exemplary embodiments of the invention are directed to optimizing the replacement of a separator insert of a separator for the benefit of its subsequent disposal, which is as uncomplicated as possible. In particular, the separator insert can be used or designed as a disposable element so that the separation process can be better controlled.

The design of the separator is intended to reduce cross-contamination during the processing of products.

For this purpose, a separator insert is used as a pre-assembled, replaceable unit within a separator. At the same time, the replaceable separator insert should be disposed of in a simple and uncomplicated manner. In particular, it should be possible to dispose of the separator insert and any residual liquid in it separately.

In a first variant, the separator insert can be provided for insertion into stator units on a frame of the separator. In this variant, the separator insert can comprise both a rotatably mounted drum and a housing that is stationary during separation operation as a pre-assembled replaceable unit.

In a second variant, the separator insert can be designed as a rotor with a rotatably mounted drum, preferably with an integrated separating means, in particular a separating disk stack, for insertion into a housing of a separator. The feed and discharge system, i.e., the entirety of all feed and discharge lines, can preferably and advantageously be at least partially or completely part of the separator insert, so that a hermetically sealed feed and discharge with respect to the housing of the separator is ensured. In contrast to the previous variant, the housing in this variant remains part of the separator when the separator insert is replaced. A disadvantage compared to the first variant is the more complicated seal between rotating and non-rotating parts. An example of such a seal and a corresponding axially arranged inlet and outlet system is known, for example, in EP 2 864 053 B1. For a supply line from below, so-called mechanical seals can be used, which make it possible to replace the separator insert. Such a seal is known, for example, from WO 2020/120358 A1.

In both of the aforementioned variants, the separator insert has at least the following features:
i. a rotor rotatable about a rotational axis with a drum and a drum wall. In a preferred embodiment, this can have a closed wall in a central area of the drum,
   In the context of the present invention, the central area is preferably defined as the area between 20-80% of the axial extension of the drum.
ii. at least two rotor units as partial elements of the magnetic bearing devices at two axially spaced locations of the rotor with the drum, with which the rotor with the drum can be held in suspension, rotatably mounted and set in rotation within the housing during separation operation,
wherein the separator has at least one linear drive for linear movement of at least one of the two receptacles relative to the separator insert (II, III).
   Decoupling from the magnetic bearing device when replacing the separator insert may require additional force. If the separator insert has a corresponding dead weight, the linear drive supports the decoupling and thus the replacement of the insert.
   The separator can also have other components, including
iii. preferably a separating means arranged in the drum,
   A disk stack consisting of separating disks can be used as a separating means.
iv. at least one product feed line and two product discharge lines from the separator insert;
   Advantageously, a separate drainage discharge line can be provided to further reduce cross-contamination. In the context of the present invention, this is preferably not assigned to the discharge system.
v. wherein the product-contacting areas of the separator insert are partially or completely made of plastic;
   In its single-use function, the use of plastic for the separator insert is ideal for the subsequent disposal of the separator insert or at least the areas in contact with the product. This is advantageous for the processing of many different products in pharmacy, radiotracer analysis, or biotechnology, e.g., in the extraction of phytotoxic substances, in which contamination should be kept to a minimum even when changing the separator insert.

A method of replacement may comprise at least the following steps.
a) Providing the separator with a first separator insert (II) mounted on the frame (I) or in the housing
   This first separator insert is replaced after use with a second non-contaminated and otherwise preferably identical separator insert. However, it is also possible for the separator inserts and preferably the separating means of the separator inserts to vary depending on the separation task.
b) Introducing a starting product to be separated into the separator;
c) Discharging a first and second product stream separated from the product mixture through the two separate product discharge lines from the separator during a separation operation of the separator;
   Separation operation is also referred to as “operation” for short below. The products are separated according to their density in the centrifugal field of the separator.
d) Stopping the separation operation and drain any residual liquid remaining in the drum;
   When the separation operation is stopped or halted, any residual liquid remaining in the drum is drained, preferably by gravity.
   The drum can still move to a small extent when the separation operation stops, but gravity prevails and determines the emptying direction.
   If a separate drainage line is used, it is preferably located along a bottom surface of the separator insert to ensure that the insert is emptied as completely as possible.
   If step d) is carried out with a separator insert in which the housing and rotor are combined in a pre-assembled unit, the drainage can be arranged in such a way that both the drum and the housing are drained of residual liquid via the drainage discharge line. More than one drainage line can also be provided for this purpose.
e) Replacing the emptied contaminated separator insert from the frame or housing of the separator with an unused separator insert.

The emptied, contaminated separator insert can then be disposed of without having to drain the residual liquid. When processing particularly problematic products, e.g., hazardous substances of different hazard classes, it is advisable to immediately pack the separator insert in contamination-proof packaging. Draining off residual liquid when the separator insert is dismantled is impractical and may require increased safety standards.

In a particularly preferred embodiment variant of the invention, the processing of the starting product, e.g., a suspension, is processed by a separator having a frame and a separator insert arranged in a replaceable manner on the frame, wherein the separator insert is designed for separating a flowable suspension in a centrifugal field into at least two flowable phases of different density and forming a pre-assembled, replaceable unit for insertion into stator units on the frame of the separator and having at least the following: a housing that is stationary in operation and is designed in the manner of a container that is closed except for a plurality of openings, a rotor arranged within the housing and rotatable about a rotational axis with a drum which has one or more openings, preferably a separating means arranged in the drum, at least two rotor units for magnetic bearing devices at two axially spaced locations of the rotor with the drum, with which the rotor with the drum can be held in suspension within the housing during operation, rotatably mountable and rotatable within the housing during operation, wherein furthermore spaced apart receptacles with stator units of the bearing devices are formed on the frame, between which the housing of the separator insert is held non-rotatably so that the rotor remains rotatable, wherein the relative position of the receptacles with the stator units of the bearing devices can be changed in such a way that the separator insert can be replaced, wherein the housing and the receptacles have corresponding positive locking means in order to hold the housing non-rotatably on the receptacles.

“In operation” means during centrifugal processing when the rotor is turning.

It is thus possible to create a separator that has a disposable module with disposable components “drum” and “housing”, whereas at least the frame and parts of the bearing and drive device can be reusable. By changing the position, the corresponding positive locking means can be brought into and out of engagement in order to replace the separator insert.

The invention makes it possible to manufacture a separator in which a disposable separator insert can be used, which is preferably designed in such a way that all product-contacting components are made of plastic or other non-magnetic materials that can be disposed of after a single use. This eliminates the need for cleaning after use. The machine and its operation can thus become significantly cheaper. Magnets can optionally be recycled.

It is simple and safe to have spaced-apart receptacles for the bearing devices on the frame, between which the separator insert can be inserted in a replaceable and rotationally fixed manner.

It may also be provided that the separator insert can be attached in a rotationally fixed manner to the frame in a form-fitting and force-fitting manner.

According to a particularly simple variant, the receptacles and the housing can have corresponding pins and recesses as corresponding positive locking means in order to hold the housing on the receptacles so that it cannot rotate. It is particularly simple if the receptacles and pins each extend axially.

It may also be provided that the position of the receptacles, in particular on the backet, can be adjusted in order to be able to replace the separator insert. For this purpose, the relative distance between the receptacles can be adjustable, but one or both receptacles can also be hinged, pivotable, rotatable, or displaceable in order to be able to place the separator insert between the receptacles. Preferably, according to one variant, the relative vertical position can be changed by adjusting the vertical relative spacing of the receptacles with the stator units of the bearing devices in such a way that the separator insert can be replaced, so that the corresponding positive locking means can be brought into and out of engagement by the adjustment.

This makes it quick and easy to change the separator insert after processing a batch.

According to a particularly simple first variant, only one of the two receptacles can be arranged on the frame, in particular on the bracket, in an adjustable manner, in particular in a height-adjustable manner, and the other receptacle can be arranged in a fixed position on the frame, in particular on the bracket. Alternatively, it is possible for both receptacles to be arranged on the frame, in particular on the bracket, in an adjustable manner, in particular in a height-adjustable manner.

As previously mentioned, the separator insert can have an additional drainage discharge line for draining the residual liquid remaining in the drum in step d). In particular, this is provided in addition to the inlet and outlet system of the separator insert. This makes additional bypasses and regulating elements superfluous, in contrast to draining via a bottom-side inlet.

Draining the residual liquid remaining in the drum in step d) can involve collecting the residual liquid outside the separator insert in a collection container, preferably a drainage bag. In this way, the residual liquid can be transferred from the preferably hermetic environment of the separator insert into a likewise hermetic environment of a contamination-tight collection container immediately before replacement. The contents of the collection container can be determined by measuring the weight of the empty container and the filled container, so that the weight of the residual liquid can be determined very precisely. In the case of hazardous substances, e.g., phytotoxins or radionuclides, an exact determination of the residual quantity may be necessary due to various national regulations.

The residual liquid remaining in the drum can also be drained via a product feed line as an alternative to a drainage discharge line by draining in step d). If the product feed line is part of the replaceable separator insert, it can also be replaced automatically. If a part of the product feed line or a part of the feed system with product-contacting surfaces is part of the housing, this part can preferably be designed to be replaceable so that it can be disposed of together with the separator insert. However, this may entail additional disassembly steps.

The product feed line or a downstream line element connected thereto, preferably a hose or pipe, can have a changeover valve between a residual liquid collection container and an output product container, with the changeover valve being actuated during draining in step d). A control unit can carry out both the operating sequence of the process described and the actuation of the changeover valve, as well as any other components for operating the separator, e.g., a peristaltic pump.

In a variant of the present invention, the separator insert can be designed as an replaceable, rotatably mounted rotor with an integrated inlet and outlet system within the housing of the separator, wherein the introduction of the starting product in step b) and the discharge of the residual liquid in step d) takes place via the product feed line of the feed system, wherein prior to the discharge of the residual liquid in step d), an inlet element connected to the product feed line is exchanged for a discharge element with the collection container.

The central closed-walled area of the drum can advantageously extend over 20-80% of the axial extension of the drum.

Particularly in the first variant, in which the separator insert has the housing and the rotor, it is advantageous if at least one product discharge line, in particular the product discharge line of a heavy product flow, is connected to a pump, such as a peristaltic pump, in particular a peristaltic squeeze pump, wherein the pump is used to adjust the pressure in the product discharge line. This allows the pump to generate a counterpressure to a product discharge of the heavy phase within the separator insert, which is designed as a gripper, e.g., by reducing the flow volume.

The pump can be switched off during draining in step d) or operate at a reduced pressure compared to step c), so that the residual liquid can flow out by gravity. Alternatively, the product discharge line can also have a regulating element for pressure reduction, preferably a valve, particularly preferably a stop valve, so that draining via the drainage discharge line is ensured. Alternatively, or additionally, the residual liquid can also be pumped out via this drainage discharge line with negative pressure.

Furthermore, the residual liquid can be advantageously drained from both the drum and the housing in step d). This applies in particular to the first variant in which the housing and drum are part of the separator insert.

Removal of the contaminated first separator insert in step e) for replacement with a new second separator insert can advantageously be carried out by changing the relative position of the receptacles with the stator units of the bearing devices.

An advantageous and simple method for changing a first separator insert of a separator in step e) for a second separator insert can be carried out particularly preferably with the following steps of:
a) providing the separator with a first separator insert mounted on the frame,
b) adjusting the relative position, in particular the relative distance, of the receptacles and releasing the positive lock between the frame and separator insert and removing the first separator insert from the receptacles;
c) providing the second separator insert (before, during, or after steps a) and b);
d) inserting the other second separator insert into the one of the receptacles so that the corresponding positive locking means at one end of the housing and at one of the receptacles engage with each other; and
e) adjusting the relative position, in particular the relative distance, of the receptacles until the corresponding positive locking means at both ends of the housing of the separator insert and at the two receptacles engage with each other in a rotationally fixed manner.

The discharge of a first and second product stream separated from the product mixture through the two separate product discharge lines from the separator during a separation operation of the separator can advantageously take place in such a way that there are no connections between the product feed system and product discharge system outside the separator insert. This ensures hermetic, contamination-free discharge of the product feed and discharge flows.

Furthermore, a first and second product flow separated from the product mixture can be discharged from the separator through the two separate product discharge lines during a separation operation of the separator in such a way that there are no connections between the product discharge system and the drainage discharge system outside the separator insert. The drainage discharge system preferably comprises the aforementioned drainage discharge line, optionally an additional pipe or hose line connected to the drainage discharge line outside the separator insert, and the aforementioned collection container.

In addition, when the separator stops separating in step d), residual liquid is preferably drained from the separator in such a way that there are no connections between the product feed system and the drainage discharge system outside the separator insert.

This means that the product feed and/or the product discharge are also hermetically sealed from the drainage system, which prevents cross-contamination.

The drainage discharge line comprises a connection piece integrally formed on the housing so that it is medium-tight, with a surface in contact with the product and a pipe or hose connected to it, preferably hermetically, for draining the residual liquid into the collection container. The connection piece protrudes outwards from the housing. Preferably, the connection piece protrudes from the adjacent outer wall of the housing.

The housing preferably has a product feed with a feed line, as well as a first and a second product discharge, with the drainage discharge line being arranged as a separate line opposite the product feed and product discharge.

The feed line can have a feed connection piece that protrudes into the interior of the housing. This creates a height difference between the feed opening and the opening of the drainage discharge, so that it is not necessary to close the product feed to drain off the residual liquid.

The hose or pipe lines can have a sterile coupling at the end.

The product feed system can advantageously have a pump, preferably a centrifugal pump, which is preferably replaced after the stop in step d).

The product feed system, the product discharge system and the drainage system can preferably comprise replaceable systems, in particular hoses or pipes attached to or on the product feed line, the product discharge lines and/or the drainage discharge lines.

Advantageously, a flow rate of the product feed or a physical measured value equivalent to the flow rate can be determined to regulate the pump output, in particular by a measurement without medium contact.

The pump and the flow meter can be arranged in a riser of the product feed system for optimum measurement value acquisition.

A drain of a heavy phase of the product drainage system may comprise a pump, preferably a peristaltic pump, which remains as part of the separator after the stop in step d), while the line element connected to the pump is replaced.

The discharge of the heavy phase can have a flow meter and/or a pressure sensor for adjusting the pressure in the drain of the heavy phase based on the speed of the pump, wherein at least the flow meter is arranged along a riser.

A container in which the light phase is temporarily stored can be advantageously arranged in a discharge of the light phase.

An optical sensor for quality control, preferably fluid-mechanically behind the container, can preferably be arranged in the discharge of the light phase.

A pump can also be arranged in the discharge of the light phase, preferably fluid-mechanically behind the container.

The pump output can be regulated by measuring the weight of the container, preferably using a load cell.

The amount of residual liquid drained in step d) can also be measured for reasons of balancing, among other things.

Advantageously, before or during steps b) and c), a protective gas, preferably nitrogen or an inert gas, can be introduced into the separator insert, in particular through one or more connection pieces arranged separately from the product feeds and outlets on the housing of the separator insert.

Furthermore, air can advantageously be extracted from the separator insert through the connection piece(s) before step b), e.g., in order to subsequently flood the separator insert with inert gas.

Finally, air can be introduced into the separator insert through the connection piece(s) to speed up and ensure complete emptying during emptying of the separator insert according to step c).

The following are further advantageous designs, which relate in particular to the first variant of the separator insert of a separator according to the invention.

It is also particularly advantageous and simple in terms of design if one or both receptacles are slidably arranged on the frame, especially on the bracket.

It is also advantageous if, when inserting the separator insert into one or both of the receptacles, one or more axially extending hoses are guided on the separator insert through a respective through-opening of the respective receptacle.

It is preferable, as it is simple and practical, that the rotor units are arranged at the two axial ends of the drum and that two corresponding stator units are formed on the frame of the separator. In this way, magnetic bearing devices are formed at both axial ends of the drum.

It is particularly advantageous here that the functionally required position of the stator units and the rotor units in relation to each other is mechanically ensured in accordance with the invention. This applies in particular to the precise axial and radial centering of the stator and rotor units, which lie coaxially one inside the other.

The invention also provides a separator insert for separating a flowable suspension in a centrifugal field into at least two flowable phases of different densities, which forms a pre-assembled, replaceable unit for insertion into stator units on the frame of the separator and has at least the following: a housing that is stationary during operation and is designed in the manner of a container that is closed except for one or more openings, a rotor that is arranged inside the housing and can rotate about a rotational axis and has a drum which has one or more openings, a separating means arranged in the drum, at least two rotor units for magnetic bearing devices at two axially spaced locations of the drum, with which the rotor with the drum can be held in suspension, rotatably mounted and set in rotation within the housing during operation, wherein the housing has positive locking means to hold the housing non-rotatably on an abutment. This separator insert is particularly suitable for a separator as a replaceable module, with the frame, in particular its receptacles, forming the abutment(s).

According to an advantageous variant, at least one of the two magnetic bearing devices preferably also represents the rotary drive for the drum, wherein this drive is also suitable for driving the drum at freely adjustable speeds or in a freely selectable direction of rotation. It may preferably be provided that one or both magnetic bearing devices act as radial and axial bearings and keep the rotor suspended in the container at a distance from it during operation.

Together, the rotor and stator units form magnetic bearing units. These can be used to support the drum axially and radially and keep it suspended.

According to a further advantageous and structurally particularly easy to implement variant, it is additionally provided that a further opening of the drum is designed as a free radial outlet for a second of the flowable phases from the drum into the housing, from which it can be discharged. It can also be advantageous and simple to provide a catch ring chamber of the housing associated with the free outlet, which has a discharge from the housing.

According to another advantageous variant that is particularly easy to implement in terms of design, however, it may also be additionally provided that a further opening of the drum for discharging the further flowable phases from the drum is formed as a paring disk. It may then be advantageously provided that the paring disk has a discharge pipe formed coaxially to the feed pipe and is guided coaxially to the latter out of the drum and through the opening in the first axial boundary wall of the housing.

In order to control the separation process well, i.e., to be able to control or regulate it, it may also be provided that a regulating valve is connected downstream of the first paring disk and/or the second paring disk on the flow side—i.e., possibly on the outlet side in each case—which can be controlled by a control device.

It may also be preferably provided that a disk stack is arranged in the drum as a separating means and that a paring disk is arranged in the drum below the distributor and below the disk stack in a space-saving and simple design, i.e., in an area that is otherwise often required for fastening a drive spindle, which is not required here. This paring disk is used to discharge the first flowable phase from the drum.

It is preferable—as the design is simple and safe—that the rotor units for the magnetic bearing devices are arranged at the two axial ends of the drum and that the feed pipe and the discharge pipe of the first paring disk each pass axially through one of these two rotor units.

It is particularly advantageous and practical for the separator insert to be designed as a pre-assembled unit. In particular, it may also be provided that all product-contacting elements of this insert are made of plastic or another non-magnetic material, wherein it can be replaced as a whole and can be completely disposed of after use. Cleaning and, optionally, steam sterilization of the separator insert are therefore no longer necessary.

The respective bearing device, which in addition to a radial bearing also effects an axial bearing of the drum and/or a rotary drive, can act permanently and/or electromagnetically.

On the outer circumference, the feed pipe or a paring disk shaft surrounding it is preferably inserted into the housing in a sealed manner or formed in one piece with it.

The drum can be single conical or double conical. In addition, or alternatively, it can also have one or more cylindrical sections. It can also be composed of several parts, in particular an upper part and a lower part, wherein these parts are preferably joined together after the installation of internal components and their assembly (e.g., by gluing or welding). Similarly, the housing can be composed of several parts, in particular an upper part and a lower part, wherein these parts are preferably joined together after the installation of internal components—in particular the rotor—and their assembly (e.g., by gluing or welding).

The drains can have connection pieces on the outside of the housing, which are sealed to the outer circumference of the housing so that hoses or the like can be easily connected. The hoses can also be pre-assembled on the connection pieces so that they are completely sealed and germ-free if required. The connection pieces can, for example, extend radially, tangentially or at an angle to the radial direction.

After its manufacture, the entire separator insert can also be provided as a sealed unit into which no impurities can enter. For this purpose, the connection pieces at the openings of the housing can be sealed and detachably closed. For example, hose sections can be arranged on the connection pieces, which have openable and closable connectors with which the separator insert can be connected to other elements of the feed and discharge system such as bags or tanks or hose or pipe lines.

These separators are suitable for operation at variable, even relatively high speeds. They can also be used for one-off processing—for example for centrifugal separation of a product batch of a flowable fermentation broth as a suspension—from e.g., 100 l to several thousand, e.g. 4000 l—into different phases—and then disposed of. A particular advantage here is that all product-contacting components of the separator can be installed, operated, and then disposed of as a prefabricated and already aseptic unit. This prefabricated unit consists of at least the rotor with the drum, the separator disks, the inlet distributor, and the rotor magnets or rotor units, as well as the housing with the feeds and discharges. Furthermore, the unit can also contain feed and discharge lines (e.g., hoses), as well as measuring equipment or other components that come into contact with the product, which are intended for single use and are disposed of together with the separator unit after use.

Finally, it may also be advantageous for the housing to have only the openings for feed pipes and outlets and otherwise be hermetically sealed. For this purpose, it may be provided that the feed pipes and the outlets protrude outwards from the housing in the manner of connection pieces, wherein these connection pieces are connected to the housing in a sealed manner or are formed in one piece with the housing.

Each of the receptacles can have a separate linear drive for linear movement of one of the two receptacles relative to the separator insert.

Alternatively, only one of the two receptacles can have a linear drive, wherein the two receptacles can be moved simultaneously, preferably synchronously. The simultaneous or synchronous movability can be achieved particularly preferably by a gear, e.g., a toothed gear, which is part of the separator.

The frame can have a support plate that allows the separator insert to be temporarily supported when it is inserted into the frame.

The support plate can have a support device, preferably a support strut, particularly preferably a telescopic rod, especially a spring-loaded telescopic rod.

In particular, the support plate has a recess for accommodating the separator insert. The recess can allow the separator insert to be gripped completely or partially, e.g., by two legs. In this context, the recess does not need to be completely closed.

At least one of the receptacles, preferably each of the receptacles, can have a through-opening through which a hose for supplying and/or discharging the product is guided, and the receptacle is mounted so that it can move linearly relative to the hose. The drive, e.g., a motor, is preferably arranged around the through-opening.

In particular, the linear drive can have a driver and a stator, wherein the driver is designed as a carriage and is attached to one of the receptacles and wherein the stator is designed as a guide rail and is attached to the frame, preferably to a bracket of the frame.

The driver can be reliably attached to one of the receptacles.

The separator insert can have one or more circumferential stops to rest on the support plate. This can be a circumferential collar, for example, which enables a wide-area support.

In particular, the receptacles can be designed to move by the same amount in order to achieve optimum force absorption during disassembly.

### BRIEF DESCRIPTION OF THE DRAWING FIGURES

In the following, the invention is described in more detail with reference to the drawing by means of exemplary embodiments, wherein further advantageous variants and designs are also discussed. It should be emphasized that the exemplary embodiments discussed below are not intended to describe the invention exhaustively, but that variants and equivalents not shown are also feasible and fall within the scope of the claims, wherein:

FIG. 1: shows a schematic, sectional representation of a first replaceable separator insert of a separator, together with a schematic representation of a feed and discharge system and a control unit of the separator;

FIG. 2: shows a schematic, sectional view of a second replaceable separator insert of a separator together with a schematic view of a feed and discharge system and a control unit of the separator;

FIG. 3: shows a schematic representation of a separator with a reusable frame and a replaceable separator insert, the latter here of the type shown in FIG. 1, with hose sections arranged on it;

FIG. 4: shows a perspective view of the replaceable separator insert from FIGS. 1 and 3 with hose sections arranged on it;

FIGS. 5-7 show three successive steps when inserting the replaceable separator insert of FIG. 4 into the frame of FIG. 3;

FIG. 8 shows a perspective view of a modification of the separator and the separator insert of FIGS. 1-7 as a further exemplary embodiment;

FIG. 9 shows a schematic representation of an installation for carrying out a process for replacing a separator insert;

FIG. 10 shows a perspective view of a separator insert in a modification of the variants of FIGS. 1-8 with an integrated drainage discharge line;

FIG. 11 shows another embodiment variant with a rotor as separator insert and a housing as a fixed, non-replaceable component of the separator;

FIG. 12 shows a further embodiment variant of a separator insert, which has at least one connection piece on its housing for supplying or discharging gas; and

FIG. 13a further design variant of a separator according to the invention with separator insert.

### DETAILED DESCRIPTION

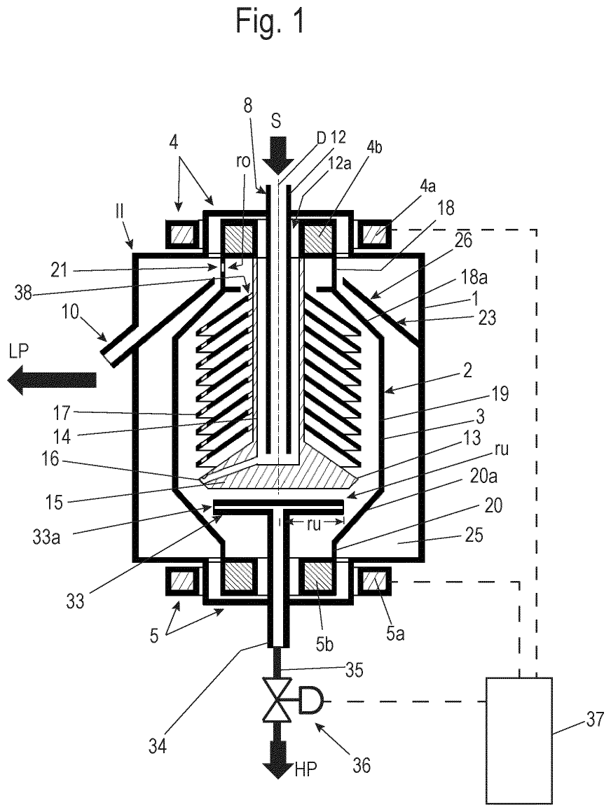

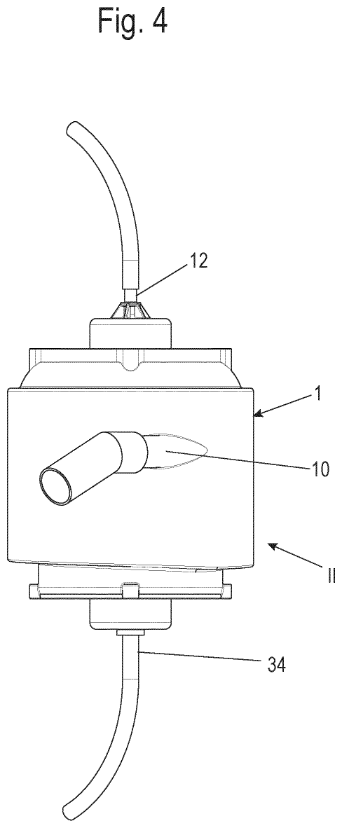

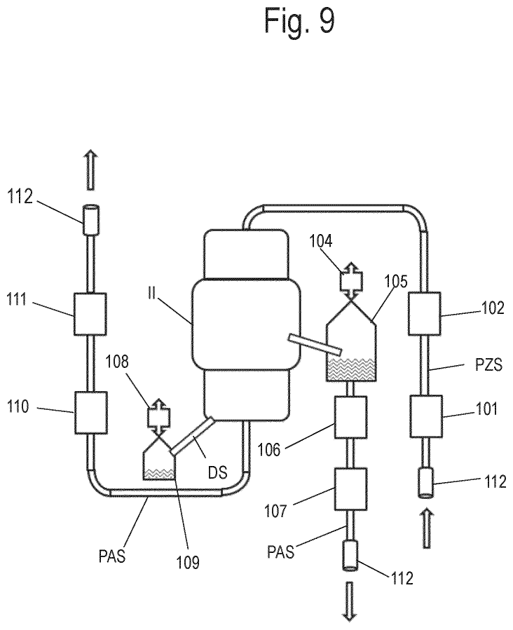

FIGS. 1-13 shows several separators with a reusable frame I and with a replaceable separator insert II for centrifugal separation. The separator insert can be replaced in particular by the embodiment variants shown in FIGS. 9-12, in which a drainage discharge line 120 is provided.

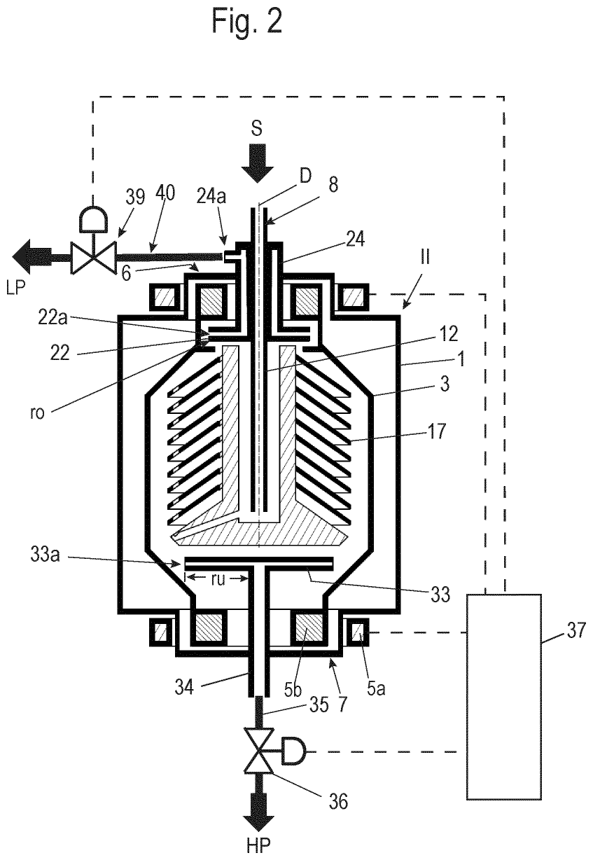

In principle, the separator insert could also be designed in the same way as in FIG. 1 or FIG. 2 and, optionally, supplemented by a non-displayed drainage discharge line.

The separator insert II is preferably designed as a prefabricated unit. In particular, the separator insert II is designed as a disposable separator insert that can be exchanged or replaced as a whole and is designed as a pre-assembled unit, which is made entirely or predominantly of plastic or plastic composites.

The separator insert (which does not include elements 4a and 5a) is shown separately as an example in FIGS. 1 and 2. It can be disposed of after processing a product batch and replaced with a new separator insert II.

According to FIGS. 1 and 2, the separator insert II of the separator has a housing 1 and the rotor 2, which is inserted into the housing 1 and can rotate relative to the housing 1 during operation. The rotor 2 has a rotational axis D. This can be aligned vertically, which corresponds to the structure of the frame I. However, it can also be aligned differently in space if the frame is also designed accordingly.

The rotor 2 of the separator insert II has a rotatable drum 3. The rotor 2 is rotatably mounted at two locations axially spaced apart from each other in the direction of the rotational axis with respective magnetic bearing devices 4, 5. Preferably, the rotor 2 or the drum 3 is rotatably mounted at both axial ends. The separator insert II has rotor units 4b, 5b of the magnetic bearing devices 4, 5. On the other hand, stator units 4a, 5a of the magnetic bearing devices 4, 5 are arranged on the frame I-1.

The magnetic bearing devices 4, 5 preferably act radially and axially and preferably keep the rotatably mounted rotor 2 suspended in the housing 1 at a distance from it.

Such a separator with an easily replaceable separator insert can be useful and advantageous when processing products where it can be ruled out with a very high degree of certainty that impurities will be introduced into the product—a flowable suspension or its phases—during centrifugal processing or where cleaning and disinfecting the separator would be very time-consuming or not possible at all.

The frame I has a bracket I-1. This can—but does not have to—be mounted on a carriage I-2 with rollers I-3. Receptacles I-4 and I-5 can be formed on the bracket I-1, which serve to receive and hold the separator insert II, even during operation. Preferably, a first axial end of the separator insert II projects from below into or towards the upper receptacle I-4 and a lower end of the separator insert II projects from above into or towards the other receptacle I-5, and the separator insert II is held non-rotatably on the bracket I-1 and thus on the frame I.

One or both of the receptacles I-4 and/or I-5 can be arranged laterally on the frame I, in particular the bracket I-1. According to a variant, it may be further provided that, for example, the lower receptacle I-5 is designed to be stationary on the bracket I-1. It is then advantageous that the further upper receptacle I-4 is designed to be height-adjustable on the bracket I-1.

In this case, it is advantageous if the bracket I-1 has such a vertical extension/length that the separator insert is held stationary in a first position of the height-adjustable receptacle I-4 by both height-adjustable receptacles I-4, I-5 and can be changed in the other upper position.

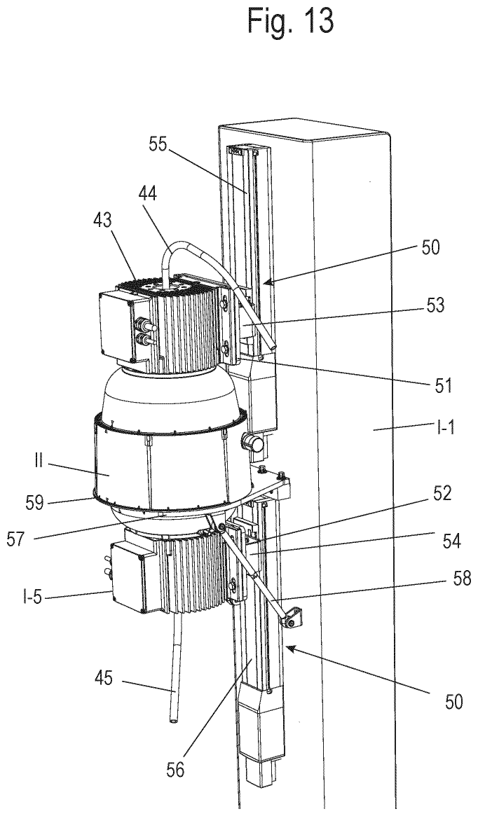

It is advantageously provided that the receptacles I-4 and I-5 with the stator units 4a, 5a on the frame I can be moved axially apart and towards each other again in order to replace the separator insert II, i.e., in order to be able to remove the old separator insert II from the frame I and replace it with a new one. This can be realized, for example, as shown in detail in FIG. 13, with one or more electric linear drives 50, wherein the stator or stators 55, 56 of the linear drives 50 are each attached to the bracket I-1 and the driver or drivers 53, 54 of the linear drive or linear drives 50 are connected to the respective receptacles I-4 and I-5. Such linear drives 50 are required for larger drive and magnetic bearing devices, as the separation of the rotor unit with the permanent magnet from the stator unit requires considerable force.

The stators 55, 56 are designed as guide rails. Both receptacles I-4 and I-5 can also be moved via a single linear drive with the aid of the additional linear guide. In this case, the movement of both receptacles can be synchronized in a particularly preferred manner.

The drivers 53, 54 can be designed as carriages. The drivers 53, 54 are connected to the remaining receptacle I-4 or I-5 via a mechanical interface 51, 52, for example via a flange connection.

It is thus provided that the relative distance between the receptacles I-4 and I-5 and the stator units 4a, 4b of the bearing devices 4, 5 can be adjusted by means of linear drives in order to be able to change the separator insert II.

To remove the separator insert II, the upper receptacle I-4 is first lifted using the linear actuator of the linear drive, which is a linear motor, for example. The separator insert II rests on a support plate 57. For this purpose, the separator insert II can have a circumferential collar 59 as a stop element. The support plate 57 preferably has two legs, in particular symmetrical legs, which partially surround the separator insert II. Alternatively, the support plate 57 can also completely surround the separator insert II. The support plate 57 is supported on the bracket I-1 by a support strut 58. This support strut 58 can preferably be designed as a telescopic rod.

Due to its weight and the holding force of the lower drive and magnetic bearing device, the separator insert II is not lifted and remains on the support plate. The lower receptacle I-5 is then lowered with the aid of the linear motor, wherein the support plate 57 serves as an abutment for the force to be applied in order to separate the stator unit of the lower drive and magnetic bearing device from the rotor unit with the permanent magnet. As soon as the receptacles I-4 and I-5 have been moved apart in this way, the separator unit II can be removed.

A new separator unit II is inserted in reverse order. When receptacles I-4 and I-5 are moved apart, separator unit II is placed on support plate 57. Suitable positive locking means between support plate 57 and separator unit II prevent incorrect positioning of the separator unit. The lower receptacle I-5 is then lifted with the linear drive until the stator unit and the permanent magnet of the rotor unit are correctly positioned in relation to each other. Then the upper receptacle I-4 is lowered with the linear drive until the stator unit and the permanent magnet of the rotor unit are positioned correctly in relation to each other.

The respective stator units 4a, 5a of two drive and magnetic bearing devices 4 and 5 can be arranged in the respective receptacles I-4 and I-5. The control and power electronics for this can be arranged in or on the frame I, e.g., in, on or on the bracket I-1.

Corresponding positive locking means can be formed on the receptacles I-4 and I-5 and on a housing 1 of the separator insert II, which does not rotate during operation, in order to be able to insert the separator insert II into the stator units 4a, 5a in a rotationally fixed manner. The upper and lower stator units 4a, 5a can each have aligned axes.

According to a particularly simple variant, the housing 1 and the receptacles I-4 or I-5 with the stator units 4a, 5a can have projections (e.g., pins or webs) and recesses (e.g., holes) as the corresponding positive locking means in order to hold the housing 1 in a rotationally fixed manner on the stator units and thus on the frame II. The corresponding positive locking means can also be formed directly on the frame II.

The position of these corresponding positive locking means also defines the functionally required position of the stator units 4a, 5a and the rotor units 4b, 5b in relation to each other. This applies, in particular, to the precise centering of the units 4a, 5a and 4b, 5b, which lie coaxially one inside the other. A retaining force (from above and below) can also be exerted on the housing in the axial direction by the receptacles in order to hold it in a force-locking manner if necessary.

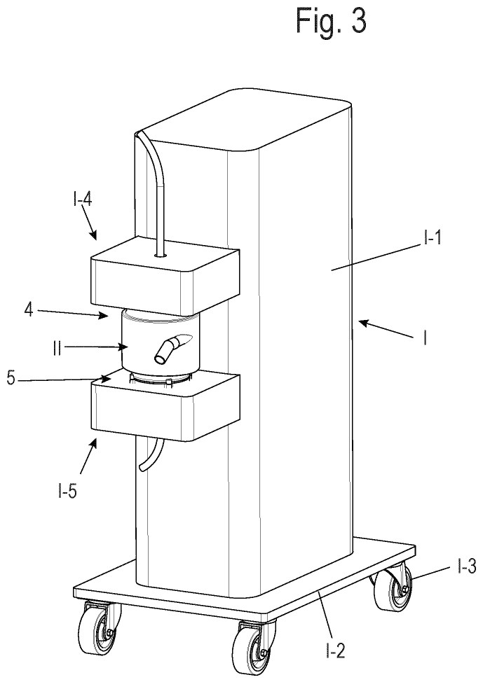

According to FIG. 3 to 7, the above measures are implemented as follows by way of example.

The receptacles I-4 and I-5 with the stator units 4a, 5a of the frame I each have a plurality of pins 41a projecting in the axial direction, and the respective separator insert II can have corresponding blind holes on the housing 1, for example extending in the axial direction, as recesses 42 or 41b.

Here, the receptacle I-4 with the stator unit 4a has axially or here vertically downwardly projecting pins 41 (not to be seen here) and the separator insert II has vertically upwardly corresponding blind hole-like recesses 42 (to be seen here) and the lower receptacle I-5 with the lower stator unit 5a has correspondingly axially or here vertically upwardly projecting pins 41a (to be seen here) and the separator insert II has axially downwardly corresponding blind hole-like recesses (not to be seen here). By way of example only, four pins 41a and recesses 41b are arranged distributed on the corners of an imaginary polygon, in particular a square, and are formed at the top and bottom of the receptacles I-4, I-5 and the housing 1 of the separator insert II.

In FIG. I-7, corresponding positive locking means 41a, 41b and 42 are arranged circumferentially distributed around the separator insert II. However, it is also possible that only one positive locking means is provided instead of several positive locking means.

However, the corresponding positive locking means can also be arranged asymmetrically to ensure that the separator insert can only be used in a single orientation.

The stator units 4a, 5a can also each have openings, in particular through-openings 43, in order to accommodate lines such as hoses 44, 45 which are connected to the separator insert II at the top and/or bottom. These are also shown analogously in FIG. 13.

One or both receptacles I-4 and I-5 is/are designed to be vertically adjustable. One of the two receptacles I-4 or I-5 can therefore also be fixed to the frame I. It is therefore also conceivable that one of the two receptacles I-4 or I-5—e.g., the lower one—is formed on a wall of the frame I and is non-adjustable. It is then sufficient to design the frame I in such a way that the respective other receptacles I-4 or I-5 are adjustable, in particular are arranged and/or designed to be vertically height-adjustable on the frame I.

This can be clearly seen from the interaction of FIGS. 3 to 7.

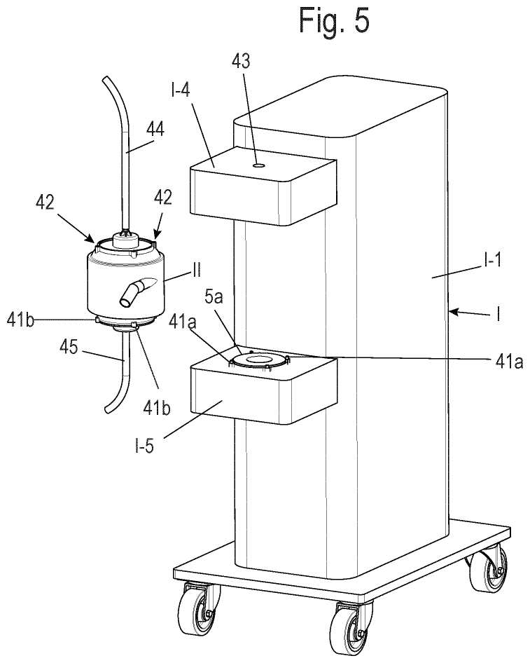

FIG. 5 shows the frame I before inserting a separator insert II.

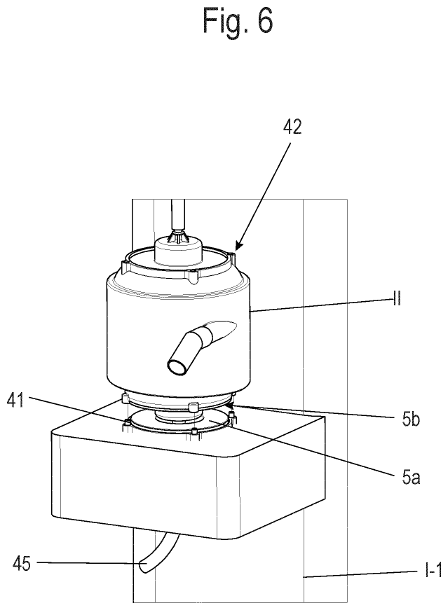

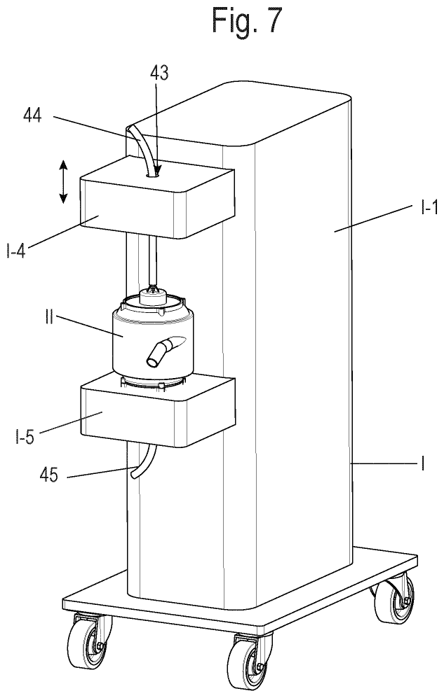

The two stator units 4a, 5a have been moved so far apart relative to each other that the respective separator insert can be lifted axially between the two receptacles with the stator units 4a, 5a (FIGS. 5, 6), wherein the separator insert II is then placed in/on the lower receptacle I-5 (FIGS. 6 and 7) in such a way that the corresponding positive locking means—here 41, 42—engage with each other. In addition, the hose 45 at the lower end of the housing 1 has been guided downwards through the through-opening 43 of the lower—and thus axially associated—stator unit 5a (FIG. 6). Now the upper receptacle I-4 is lowered until the corresponding positive locking means of the upper receptacle I-4 and the housing 1 of the separator insert I—here 41, 42—also engage securely with each other (FIG. 7). The upper hoses 44 on the housing 1 are guided through the through-opening 43 of the upper receptacle I-4. The separator insert II is now held securely on the frame I so that it cannot rotate. The centrifuging and separating process for processing a product batch in the centrifugal field can therefore begin. After the intended batch has been processed, the upper separator unit is lifted upwards again until the separator unit can be lifted out of the frame I and replaced with a new one.

With reference to FIG. 1 and FIG. 2, the further structure of exemplary preferred separator inserts II together with the structure of the drive and bearing system of the separator, the control system of the separator, and the feed and discharge system of the separator are described in more detail below. The invention is not limited to this. In particular, the inlet and outlet lines can also be realized differently on the separator insert II.

First, the rotor units 4b, 5b can be designed essentially in the manner of inner rings of magnets, in particular permanent magnets, and the reusable stator units 4a, 5a, can be designed essentially in the manner of outer rings, which are used for the axial and radial mounting of the rotor 2 (e.g., at the top) or alternatively also for the rotary drive (e.g., at the bottom).

As part of the separator drive, the rotor units 4b and/or 5b therefore also form part of the rotating system or rotor. In other words, the rotor of the drive is part of the drum of the centrifugal separator.

One or both of the magnetic bearing devices 4, 5 is/are thus preferably also used as a drive device for rotating the rotor 2 with the drum 3 in the housing 1. In this case, the respective magnetic bearing device forms a combined magnetic bearing and drive device. The magnetic bearing devices 4, 5 can be designed as axial and/or radial bearings, which support the drum 3 axially and radially at its ends in an overall interacting manner during operation and keep it suspended and rotating overall during operation.

The magnetic bearing devices 4 and 5 can have the same or largely the same basic design. In particular, only one of the two magnetic bearing devices 4, 5 can also be used as a drive device. Corresponding components of the magnetic bearings 4, 5 are thus formed on the separator insert II—on its rotor 2—and other corresponding parts on the frame I. One or both stator units 4a, 5a can also be electrically connected to control and power electronics for controlling the electromagnetic components of the magnetic bearing devices.

The respective magnetic bearing device 4, 5 can, for example, work according to a combined electro-magnetic and permanent-magnetic operating principle.

Preferably, at least the lower axially acting magnetic bearing device 5 serves to keep the rotor 2 axially suspended within the housing 1 by levitation. It can have one or more first permanent magnets, for example on the underside of the rotor, and also have electromagnets on a receptacle on the frame, which coaxially surround the permanent magnet(s). The rotor can be driven electromagnetically. However, a drive via rotating permanent magnets can also be realized.

Such bearing and drive devices are used, for example, by the company Levitronix for driving centrifugal pumps (EP2 273 124 B1). They can also be used in the context of this document. For example, a first Levitronix motor “bottom” can be used as the drive, which also supports the drum magnetically radially and axially. In addition, a second Levitronix motor—identical in construction except for the control system during operation, for example—can be provided which, as the magnetic bearing 4, can support the rotor 2 radially and axially at the head.

The rotor speed can be variably adjusted with the aid of a control device 37 (see FIG. 1 or 2) or a separate control device for the magnetic bearings 4, 5. The direction of rotation of the rotor 2 can also be specified and changed in this way.

During operation, the rotor 2 rotates, keeping it axially suspended and radially centered. Preferably, the rotor 2 with the drum 3 is operated at a speed of between 1,000, preferably 5,000 and 10,000, possibly even up to 20,000 revolutions per minute. The centrifugal forces resulting from the rotation lead to the separation of a suspension to be processed into different flowable phases LP, HP of different densities, as described above, and to their discharge, as described in more detail below. The product batch is processed in continuous operation, which means that the phases separated from the suspension are completely discharged from the drum during operation.

This makes it very possible to create a separator insert and housing for a separator that can be designed for single-use overall, which in turn is of particular interest and advantage for processing pharmaceutical products such as fermentation broths or the like, since no cleaning of the drum has to be carried out after operation for processing a corresponding product batch in preferably continuous operation during processing of the product batch, since the entire separator insert can be replaced. Optionally, individual elements such as magnets can be suitably recycled (see also DE 10 2017 128 027 A1).

The housing 1 is preferably made of a plastic or plastic composite material. The housing 1 can be cylindrical and have a cylindrical outer casing, at the ends of which two radially extending boundary walls 6, 7 (cover and base) are formed.

The drum 3 is used for centrifugal separation of a flowable suspension S in the centrifugal field into at least two phases LP, HP of different densities, which can be, for example, a lighter liquid phase and a heavy solid phase or a heavy liquid phase.

In a preferred design, the rotor 2 and its drum 3 have a vertical rotational axis D. However, the housing 1 and the rotor 2 could also be aligned differently in space. The following description refers to the vertical alignment shown (FIG. 3). If the orientation in space is different, the alignments change in accordance with the new orientation. In addition, one or both outlets—still to be discussed—may be arranged differently.

The rotor 2 of the separator with the drum 3 preferably consists entirely or predominantly of a plastic or plastic composite material.

The drum 3 is preferably cylindrical and/or conical, at least in sections. The same applies to the other elements in the rotor 2 and on the housing 1 (except for elements of the magnetic bearing devices 4, 5).

The housing 1 is designed like a container, which is advantageously hermetically sealed except for a few openings/opening areas (to be discussed).

According to FIGS. 1 and 2, one of the openings is formed in each of the two axial boundary walls 6, 7, which are located at the top and bottom of the container 1 in this example.

One of the openings—in the first, here upper axial boundary wall 6—enables or serves as a feed 8 for feeding a suspension to be separated in the centrifugal field into at least two phases of different density—LP and HP—through the housing 1 into the drum 3.

Here, the first phase is a lighter phase LP and the second phase is a denser, heavier phase HP compared to the first phase.

A second of the openings—in the second, here lower axial boundary wall 7—allows or serves as an outlet for the second heavier phase HP directly from the drum 3 through the housing 1.

The drum 3 also has openings that are assigned to the openings of the housing.

A feed pipe 12 for a suspension to be processed extends into an upper opening 12a at the one axial end of the drum 3. This passes through the housing 1, in particular its one—here upper—axial boundary wall 6. On the outer circumference, the feed pipe 12 is sealed towards the housing 1 according to FIG. 1 and inserted into the latter—e.g., by welding or gluing—or, optionally, designed as a single piece with the housing as a plastic injection-molded part. It is preferably also made of plastic. One end of the feed pipe 12 protrudes outwards from the top of the housing 1 and extends through the upper boundary wall 6 into the drum 3 without touching the drum 3.

According to FIG. 1 (but also FIG. 2), the feed pipe 12 passes through the housing 1 and the one magnetic bearing 4 concentrically to the rotational axis of the rotor 2, then extends axially further inside the housing 1 into the rotatable drum 3 and ends there with its other end—a free outlet end.

According to FIGS. 1 and 2, the feed pipe 12 opens into the drum 3 in a distributor 13 that can rotate with the drum 3. The distributor 13 has a tubular distributor shaft 14 and a distributor foot 15. One or more distributor channels 16 are formed in the distributor foot 15. A stack of separating disks, in this case conical separating disks 17, can be placed on the distributor 13. The distributor 13 and the separating disks 17 are preferably also made of plastic.

In addition, according to both FIG. 1 and FIG. 2, a first paring disk 33 is used to discharge the heavier phase HP of the two phases HP and LP from the drum 3. A paring disk shaft or a central discharge pipe 34 passes through the second axial boundary wall 7 (see FIG. 1 and FIG. 2).

According to one possible—but not mandatory—design, the drum 3 has at least two cylindrical sections 18, 19 of different diameters. Adjacent to these, one or more conical transition areas can be formed on the drum 3. The drum 3 can also have a single or double conical design on the inside of its central axial area (not shown here).

As shown, the drum 3 can have a lower cylindrical section 20 of smaller diameter, on/in which the rotor unit 5b of the lower magnetic bearing is also formed, which merges into a conical section 20a, then here, for example, a cylindrical section 19 of larger diameter, then again a conical section 18a and then an upper cylindrical section 18 of smaller diameter, on which the rotor unit 4b of the upper magnetic bearing 4 is formed.

The separator inserts in FIGS. 1 and 2 differ with regard to the discharge of the lighter phase.

Openings (which can be provided on the drum 3 in a circumferentially distributed manner, wherein several openings can thus be provided on the drum 3 in each case) serve as radial or tangential outlet 21 of the light phase LP from the drum 3 according to FIG. 1. An opening in the outer casing of the housing then enables the outlet or serves as discharge 10 of the lighter product phase LP, which is formed during centrifugal separation and has been discharged from the drum 3, according to the exemplary embodiment of FIG. 1.

The first outlets 21 on the radius ro of the drum 3 are designed in particular as “nozzle-like” openings in the outer casing of the drum 3. They are also designed as so-called “free” discharges from the drum 3. The first outlets 21 are used to discharge the lighter phase LP. The outlets can be designed so that the light phase exits radially or, alternatively, so that the light phase exits tangentially against the direction of rotation of the drum and thus contributes to driving the rotor and reducing the drive energy. This phase emerging from the drum 3 is collected in the housing 1 in an upper catch ring chamber 23 of the housing 1. This catch ring chamber 23 is designed in such a way that the phase caught in it is directed to the discharge 10 of the catch ring chamber 23. This can be achieved by locating the discharge 10 at the lowest point of the catch ring chamber 23. The catch ring chamber 23 is open radially inwards towards the rotating drum 3 and is spaced at such a distance that liquid spraying out of the respective outlet 21 is essentially only sprayed into the associated catch ring chamber 23—which is at the same axial level—during centrifugal separation.

A chamber 25 that is not used to discharge a phase can optionally be formed below the catch ring chamber 23. This chamber 25 can optionally have a leakage drain (not shown here). The leakage can run off freely. However, it can also be extracted by negative pressure if the chamber 25 has a negative pressure connection for connecting a device that generates negative pressure.

The first catch ring chamber 23 and the chamber 25 can be separated from one another by a first wall 26, which is conical here and which, starting from the outer casing of the housing 1, extends conically inwards and upwards and ends radially in front of the drum 3 at an inner distance from the latter.

Preferably at the lowest point of the catch ring chamber, the product phase LP is discharged from the housing 1 through the discharge 10. Connection pieces can be provided on the outside of the housing 1 in the area of the discharge 10 in order to be able to easily connect lines, hoses and the like.

These can in turn be formed directly on the housing 1 or attached to it with adhesive. The connection pieces are preferably also made of plastic. The housing 1 can be made up of several plastic parts that are sealed together, for example by adhesive or welding.

As the (here second) outlet for the heavier phase HP from the drum (through the housing 1), the first paring disk 33 is provided according to FIGS. 1 and 2, which extends essentially radially and merges into an axially extending discharge pipe 34 as a paring disk shaft, which passes through the lower axial boundary wall 7 of the housing 1. The paring disk 33 has an outer diameter ru. Here, ru>ro applies. The inlet openings 33a of the paring disk 33 are therefore on a larger diameter or radius ru than the outlets 21 for the light phase LP on the radius ro. This makes it possible to use the paring disk 33 to discharge a heavier phase HP from the drum 3 relative to the lighter phase LP. The paring disk 33 is stationary during operation of the separator and dips with its outer edge into the heavier phase HP rotating in the drum 3.

The phase HP is discharged inwards through the channels in the paring disk 33. The paring disk 33 thus serves to discharge the phase HP in the manner of a centripetal pump.

The paring disk 33 can be arranged in a simple and compact manner in the drum 3 below the distributor 14 and below the disk stack 17. The radius ru corresponds to the immersion depth of the paring disk 33.

One end of the discharge pipe 34 is led out of the housing 1 downwards out of the drum and through the lower boundary wall 7, although it does not touch the drum 3. The discharge pipe 34 can be formed in one piece with the housing 1 or inserted into it in a sealed manner. A hose or the like can be connected to the drain pipe as a drain 35.

The discharge pipe passes through the housing 1 and the lower magnetic bearing 5 concentrically to the rotational axis D of the rotor 2 and then extends axially further inside the housing 1 into the paring disk 33.

It may be provided that a controllable, in particular electrically controllable, regulating valve 36 is inserted in the outlet for the heavy phase HP, in particular in the drain 35 for the heavier phase HP. The regulating valve 36 can be used to throttle the volume flow of the heavy phase HP in the drain 35 and to increase the immersion depth of the associated paring disk. A control device 37 is preferably provided. The regulating valve 36 is preferably connected to the control device 37 by a wireless or wired connection.

The control device 37 can also be designed and provided for controlling the magnetic bearings 4, 5 and the drive.

According to FIG. 2, the light phase LP is also discharged via a paring disk.

For this purpose, a paring disk 22 is provided in the upper area of the drum 3, the inlet openings 22a of which can in turn be located at a smaller radius ro than the radius ru of the inlet of the first—lower—paring disk 33 for the heavier phase.

The shaft of this paring disk 22 can surround the feed pipe 8 like an outer discharge pipe 24 and be tightly connected to the housing 1 instead of the feed pipe 8 or be formed in one piece with it. The discharge pipes 24, 34 of the two paring disks 22, 33 are thus led out of the drum 3 at opposite ends of the latter according to FIG. 2. They are also led out of the housing 1 at opposite ends of the latter. They can be inserted into the housing 1 in a sealed manner. However, they can also be made in one piece from plastic. The feed pipe 12 can be connected to the upper end of the paring disk shaft 24. A radial or tangential connection piece 24a can lead out of the paring disk shaft 24. A discharge line 40 for discharging the light phase can be connected to this, which can, for example, lead into a bag, or tank, or the like. Accordingly, the ends of the pipes 12 and 34 can also be designed as connection pieces for connecting hoses or the like (FIG. 2, but also FIG. 1).

It may be provided that a controllable, in particular electrically controllable, control valve 39 is also installed in the discharge line 40 for the light phase LP.

The regulating valve 39 can be used to change the volume flow of the light phase LP, in particular to throttle it more or less and thus change the immersion depth of the second paring disk 22. The regulating valve 39 is also connected to the control device 37 wirelessly or by wire, so that it can be controlled by the control device 37.

The respective paring disk 22, 33 is in each case a cylindrical and essentially radially aligned disk provided with several, for example one to six, channels, which is stationary during operation and has channels, so that a type of centripetal pump is formed. The outer edge of the respective paring disk 22 or 33 is immersed in the phase LP or HP rotating in the separator. The respective phase LP, HP is diverted inwards through the channels in the paring disk and the rotational speed of the respective phase LP, HP is converted into pressure. The respective paring disk 22, 33 thus replaces a drain pump for the respective phase LP, HP. The paring disks thus each work as a centripetal pump. They can be made of plastic.

Theoretically, a third paring disk could also be provided, which could be used to discharge a further phase.

The operation of the separators according to FIG. 1 and then FIG. 2 is briefly described below.

First, the respective separator is provided with its multi-use components or reusable components. This includes the frame I as well as the drive and stator units 4a, 5a of the magnetic bearing devices. This also includes a control unit 37. A separator insert II is then provided and mounted on the frame I. To do this, only the stator units 4a and 5a need to be moved apart. The separator insert is then inserted with a positive fit and the stator units are moved towards each other. This ensures that the housing is held securely against rotation. Now, optionally, hoses are connected to the connection pieces that lead into tanks or bags. The respective separator insert of FIGS. 1 and 2 can therefore preferably also have at least hoses and connection pieces that can be connected to other lines (not shown here) and containers such as bags, tanks, pumps and the like.

Then, after connecting the pipes and hoses and the like, a suspension is fed into the rotating drum (feed 8), where it is separated centrifugally into the light phase LP and the heavy phase HP.

The heavier phase HP of greater density flows radially outwards in the drum 3 in the separation chamber. There, the phase HP leaves the drum on a radius ru through the channels of the stationary paring disk 33.

The lighter phase LP flows radially inwards in the drum 3 in the separation chamber and rises upwards through a channel 38 on a shaft of the distributor. There, the phase LP leaves the drum according to FIGS. 1 and 2 at a radius ro.

The regulating valve(s) 36, 39 can be used to easily influence the separation process. This results in an optimization of the separation process.

The main application of the separator is cell separation in the pharmaceutical industry. The capacity range is intended for processing broths from fermenters in the 100 l-4000 l range as well as for laboratory applications.

Other areas of industry in which separators are used are also conceivable: Chemicals, pharmaceuticals, dairy technology, renewable raw materials, oil and gas, beverage technology, mineral oil, etc.

The separators shown enable the production of a separator insert in which preferably all components that come into contact with the product can be made of plastic or other non-magnetic materials that can be disposed of after a single use or fed into a recycling process. This eliminates the need for cleaning after use. The separator and its operation can therefore be implemented cost-effectively.

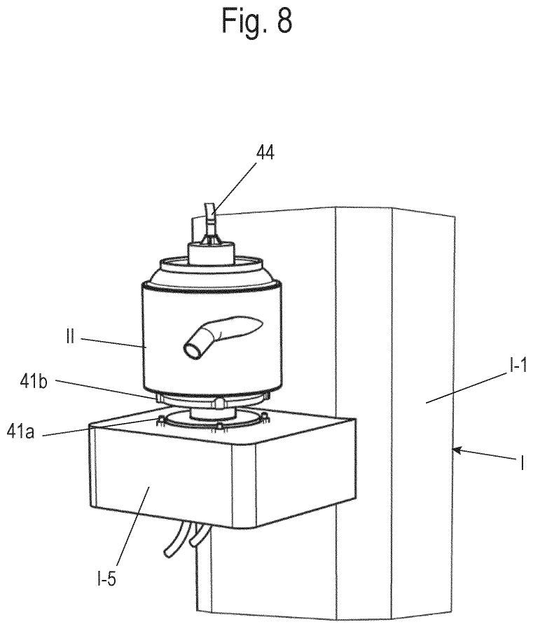

FIG. 8 shows a modification of the separator insert II of FIGS. 1-7 in a second embodiment variant, wherein identical features are provided with analogous reference signs. The special feature of this second embodiment variant is that the positive locking means 41a and the corresponding positive locking means 41b provided on the frame I are only provided on one side between the frame I and the separator insert II, thereby also enabling axial and torsional locking of the separator insert II relative to the frame I. Among other things, this reduces the complexity of the structure.

The use of the modular centrifugal separator with replaceable separator insert shown in FIGS. 1-8 ensures a sterile interior, i.e., a sterile flow path within the centrifugal separator.

Suitably, in separators with product feed and discharge system and drainage system, consisting of separator insert, feed system and discharge system, other replaceable components can also be used to provide a sterile flow path for the feed suspension and the separated light and heavy phases.

Mentioned purely as examples, the pump for the feed suspension, the hose line for the feed, the hose lines for the light phase and the heavy phase, and the container for the heavy phase can be replaceable sterile components that are suitable for separating a single product batch or a limited number of product batches. The tubing for the drainage liquid as well as the container for the drainage liquid can also be replaceable sterile components. All these components are connected to each other with sterile connectors to enable simple and at the same time sterile changing of the components. The product feed system, the product discharge system and the drainage outlet system of the separator are explained in more detail below with reference to FIG. 9.

For example, a single-use centrifugal pump 101 can be used in the inlet. This has the advantage that it is smaller than comparable peristaltic pumps with the same flow rate. The pump delivers a certain volume depending on its speed and the existing back pressure.

The flow meter 102, which is also arranged in the feed line between pump 101 and separator insert II, preferably works with a non-contact measuring principle, e.g., ultrasonic transit time difference method. This means that it can simply be pushed over the feed line without coming into contact with the product.

It can therefore be constantly reused, while the feed hose is a single-use product. The measurement signal from the flow meter is used to regulate the speed of the feed pump. In this way, a controller can set the speed of the feed pump so that the preselected setpoint for the feed volume matches the measured actual value. The pump and flow meter are arranged in the ascending feed line so that the line is always filled with liquid, resulting in a more stable measured value of the flow meter 102.

A pump 110 and a flow meter 111 are arranged in the discharge line for the heavy phase. The pump and flow meter are arranged in the ascending discharge line so that the line is always filled with liquid, which results in a more stable measured value of the flow meter 111.

The drain pump 110 is preferably designed as a peristaltic pump. One of the advantages of a peristaltic pump is that it only comes into contact with the outside of the drain hose, but is not in direct contact with the product.

It can therefore be constantly reused, while the drain hose is a single-use product. Another advantage of the peristaltic pump is that it delivers a defined volume depending on the speed. Unlike the centrifugal pump, it can be used as a throttle, i.e., it can generate a pressure in the discharge of the heavy phase, the level of which can be regulated by the control system. The pressure sensors required for this can be provided in individual or preferably all hose lines (not shown in the picture).

A container 105 is provided in the light phase discharge line, which serves as a buffer container. The quantity of light phase currently in the buffer tank is determined by means of a load cell 104 and passed on to the control system.

The light phase can be introduced from the separator insert II into the container 105 in the upper part of the container 105 (above the liquid level that is forming) or in the lower part of the container (below the liquid level that is forming). For products that tend to foam, the upper inlet has proven to be the best choice. The outlet of the container 105 is connected to a descending drain hose, which is guided by an optical sensor 106 and a peristaltic pump 107.

The speed of the pump is optimally regulated with the aid of the measurement signal from the load cell 104 so that the container 105 is never completely full and never completely empty. In this way, the drain hose is always full, resulting in a stable signal from the optical sensor 106. The signal from the optical sensor 106 is used to assess the quality of the light phase. For example, the amount of remaining sediment and suspended solids can be assessed. The pump 107 can be designed as a centrifugal pump or as a peristaltic pump. The volume of the container 105 must be selected so that the dwell time of the light phase in the container is sufficiently long for bubbles to separate from the liquid. Using the measured value from the load cell 104, the delivery rate of the pump 107 can be set so that a constant filling level is maintained approximately in the middle of the container 105.

The descending drain hose connected to the drainage outlet of the separator insert II leads into a container 109, which in turn is suspended from a load cell 108. This can be used to determine the amount of drainage liquid discharged. Drainage liquid is essentially produced when the drum comes to a standstill at the end of batch processing and runs empty via this drain.

All the hose lines in FIG. 9 then each lead into a sterile coupling 112. Not shown in FIG. 9 is the frame for holding the separator insert and the drive.

The product feed system PZS shown in FIG. 9, the product discharge system PAS comprising the product discharges of the heavy and light phases, and the drainage system PS are separated from each other outside the separator insert and are therefore hermetically sealed.

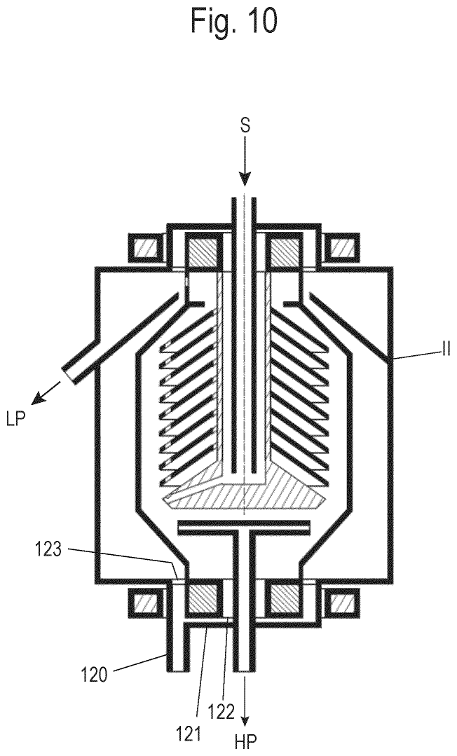

FIG. 10 shows a modification of the first variant of the separator insert II of FIGS. 1-8 for connection to the drainage system of FIG. 9. The separator insert II has a drainage discharge line 120. This is arranged in the base area 121 of the separator insert and has a liquid drain 122 and 123 both from the drum and from the housing. The remainder can be of the same design as previous embodiment variants.

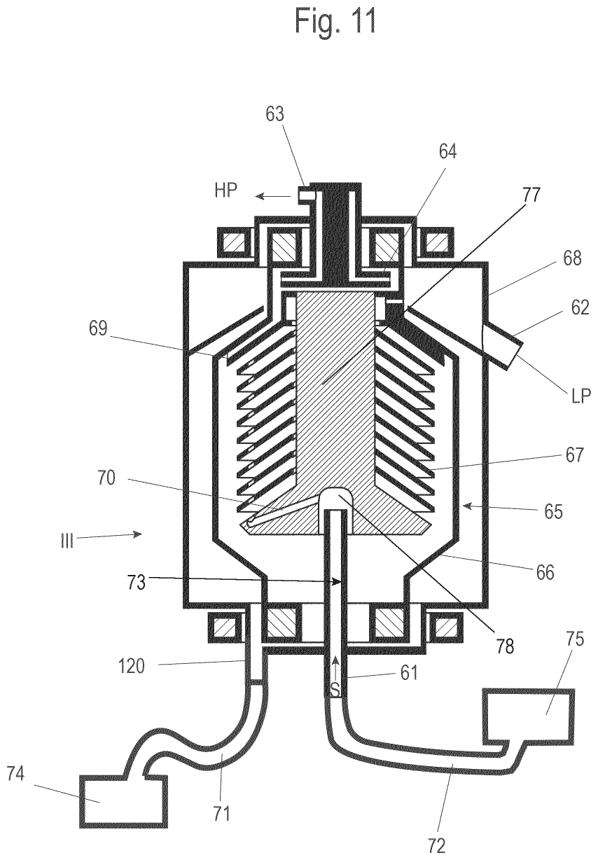

FIG. 11 shows a second variant of a separator insert III, which is replaceable. This separator insert III has a bottom-side feed via the feed line 61 and the distributor 70 into the disk stack 67. The product feed line 61 comprises a feed nozzle 73, which extends from the base of the housing 68 into the interior of the rotor 65 and opens into a distribution chamber 78 of a holding device 77 of the disk stack 67. The holding device 77 can have a longitudinal axis that is parallel to the rotational axis of the rotor 65. The channel-like distributor 70 extends from the distributor chamber 78, which allows the supplied starting product to be passed on radially into a separation zone of the rotor 65.

The product discharge 62 of the light phase takes place in the same way as FIGS. 1-10. The product discharge 63 of the heavy phase takes place by being discharged via channels in a separating disk 69, here as a closed-walled separating disk at the end of the disk stack, and finally by a gripper 64 into a discharge through the product line of the product discharge 63. At the separating disk, a separation takes place between the heavy phase and the light phase, wherein the heavy phase is guided around the outside of the plate and the light phase is guided and discharged on the inside of the plate. However, this is only one of many possible variants of a product discharge for the heavy phase.

The separator insert III can be designed in such a way that the rotor 65, in particular the drum 66 and the disk stack 67, can be removed from the housing 68. In this variant, it is also advisable to empty the rotor, in particular the drum, of residual liquid before removing the rotor as part of the present process. In this case, this can be done via the feed line 61.

It is then recommended that the feed line 61 is also replaced when the separator insert III is replaced so as not to expose a subsequent batch to cross-contamination. Accordingly, the feed line can be attached to the housing in a replaceable and medium-tight manner using non-presented seals, e.g., sealing sleeves.

FIG. 11 can be modified in many ways, but shows, in particular, that an exchange of the separator insert, which can also be applied to a separator in which only the rotor with its product feed and discharge lines is designed as a replaceable separator unit 11.

The housing 68—not shown—can be opened, for example by forming part of the housing as a cover. For this purpose, it is preferable to remove at least the upper receptacle from the cover.

In FIG. 11, the residual liquid is drained via the drainage discharge line 120 into a collection container 74 via a line element 71 connected thereto, in particular a drainage element in the form of an attached or plugged-on hose. The feed line 61, in particular the feed connection piece 72, is connected to a feed element 72, which is connected to a container 75 with the suspension of the starting product. A switching valve, not shown, can be arranged in this line element, which switches between two containers 75, e.g., in order to supply a demulsifier to improve the suspension. Alternatively, the valve can be closed and the line elements can be exchanged with the containers.

In addition, the feed element can have a pump, e.g., a squeeze hose pump, so that the liquid in the feed element is not passed through the pump itself.

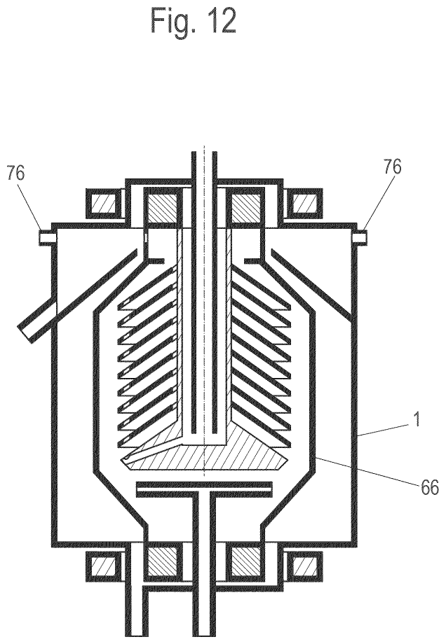

FIG. 12 shows a further variant of a separator insert II, which can be provided as part of a method for replacing it. This separator insert II has at least one connection piece 76 on its housing 1. The separator insert can be filled with an inert gas through this connection piece before the product to be separated enters the separator insert. In this way, the product to be separated is prevented from coming into contact with air or oxygen. A second connection piece 76 can be provided on the housing 1, which is provided for discharging gases from the separator insert so that the separator insert can be flushed with inert gas.

The gas can also be extracted from the otherwise hermetically sealed separator insert through the connection piece 76 in such a way that a negative pressure is created in the separator insert, which not only reduces contact with the remaining oxygen, but also reduces the frictional power of the rotating drum 66, which now rotates in an atmosphere of lower density.

Alternatively, in addition to an inert gas, a compressed gas, e.g., compressed air, can also be introduced via one or more of the gas connections 76, which additionally facilitates the emptying of the housing via the drainage line.

### LIST OF REFERENCE SIGNS

Frame I
Bracket I-1
Carriage I-2
Rollers I-3
Receptacles I-4, I-5
Separator insert II
Housing 1
Rotor 2
Drum 3
Magnetic bearing devices 4, 5
Stator units 4a, 5a
Rotor unit 4b, 5b
Radial boundary wall 6, 7
Feed 8
Discharge 10
Feed pipe 12
Opening 12a
Distributor 13
Distributor shaft 14
Distributor foot 15
Distributor channel 16
Separating disk 17
Cylindrical sections 18, 19, 20
Conical sections 18a, 20a
Outlets 21
Paring disk 22
Inlet openings 22a
Catch ring chamber 23
Discharge pipe 24
Connection piece 24a
Chamber 25
Conical wall 26
Paring disk 33
Inlet openings 33a
Discharge pipe 34
Drain 35
Regulating valve 36
Control device 37
Channel 38
Regulating valve 39
Discharge line 40
Pins 41a
Recesses 41b
Recesses 42
Through-opening 43
Hoses 44,45
Linear drive 50
Mechanical interface 51, 52
Driver 53, 54
Stator 55, 56
Support plate 57
Support strut 58
Circumferential collar 59
Pump 101
Flow meter 102
Load cell 104
Container 105
Optical sensor 106
Peristaltic pump 107
Load cell 108
Container 109
Pump 110
Flow meter 111
Sterile coupling 112
Drainage discharge line 120
Base area 121
Liquid drain 122
Liquid drain 123
Separator insert III
Feed line 61
Product discharge (light phase) 62
Product discharge (heavy phase) 63
Gripper 64
Rotor 65
Drum 66
Disk stack 67
Housing 68
Separating disk 69
Distributor 70
Line element 71
Feed element 72
Nozzle 73
Collection container 74
Container 75
Connection piece 76
Holding device 77
Distribution chamber 78
Rotational axis D
Suspension S
Phases LP, HP
Radii ro, ru
PAS Product discharge system
PZS Product feed system
DS Drainage system

1-15. (canceled)

16. A separator comprising:
a separator insert; and
a frame comprising two receptacles configured to rotatably mount the separator insert, wherein the separator insert and the frame each have a stator device as a partial element of a magnetic bearing device,
wherein the separator insert is a pre-assembled, replaceable unit configured for insertion into stator units on the frame or in a housing of the separator, and wherein the separator insert comprises at least the following
i. a rotor rotatable about a rotational axis with a drum and a drum wall,
ii. at least two rotor units as the partial elements of the magnetic bearing devices at two axially spaced locations of the rotor with the drum, wherein the at least two rotor units are configured such that the rotor with the drum are holdable in suspension, rotatably mounted, and set in rotation within the housing during separation operation,
wherein the separator further comprises at least one linear drive configured to linearly move at least one of the two receptacles relative to the separator insert.

17. The separator of claim 16, wherein the separator insert has at least one product feed line and two product discharge lines.

18. The separator of claim 16, further comprising:
a separating means arranged in the drum.

19. The separator of claim 16, wherein product-contacting areas of the separator insert are made partially or completely of plastic.

20. The separator of claim 16, wherein, in a central region of the drum, the drum wall is a closed-wall.

21. The separator of claim 16, wherein each of the two receptacles has a linear drive configured to linearly move a respective one of the two receptacles relative to the separator insert.

22. The separator of claim 16, wherein only one of the two receptacles has a linear drive, wherein the two receptacles are moveable simultaneously.

23. The separator of claim 22, wherein the separator comprises a gear configured to simultaneously move the two receptacles.

24. The separator of claim 16, wherein the frame has a support plate configured to temporarily support the separator insert.

25. The separator of claim 24, wherein the support plate has a support device.

26. The separator of claim 24, wherein the support plate has a recess configured to accommodate the separator insert.

27. The separator of claim 16, wherein at least one of the two receptacles has a through-opening configured such that a hose for feeding or discharging the product is guidable through the through-opening, and wherein the at least one of the two receptacles is mounted so as to be linearly movable relative to the hose.

28. The separator of claim 21, wherein the linear drive of each of the two receptacles has a driver and a stator, wherein the driver is a carriage and is fastened to one of the at least two receptacles, and wherein the stator is a guide rail and is fastened to the frame.

29. The separator of claim 28, wherein the driver is attached to one of the receptacles.

30. The separator of claim 22, wherein the linear drive has a driver and a stator, wherein the driver is a carriage and is fastened to one of the at least two receptacles, and wherein the stator is a guide rail and is fastened to the frame.

31. The separator of claim 16, wherein the separator insert has one or more circumferential stops configured to rest on the support plate.

32. The separator of claim 16, wherein the two receptacles are configured to move by a same distance.
